(19) United States
(12) Patent Application Publication
(10) Pub. No.: US 2026/0228541 A1
(43) Pub. Date: Aug. 6, 2026

(54) GENERATING TRAINING EXAMPLES FOR A MACHINE LEARNING BASED RECEIVER

(71) Applicant: Telefonaktiebolaget LM Ericsson (publ), Stockholm (SE)

(72) Inventors: Muris SARAJLIC, Malmö (SE); Mårten SUNDBERG, Årsta (SE); Adrian GARCIA RODRIGUEZ, Paris (FR); Hamed FARHADI, Stockholm (SE)

(73) Assignee: Telefonaktiebolaget LM Ericsson (publ), Stockholm (SE)

(21) Appl. No.: 19/146,570

(22) PCT Filed: Jan. 10, 2024
(86) PCT No.: PCT/EP2024/050488

§ 371 Date: Jul. 9, 2025

Related U.S. Application Data
(60) Provisional application No. 63/438,335, filed on Jan. 11, 2023.

(51) Int. Cl. G06N 3/09; G06F 7/58; G06N 3/048

(52) U.S. Cl. CPC G06N 3/09; G06F 7/582; G06N 3/048

(57) ABSTRACT

A method performed by a user equipment (UE) for generating training data. The method includes receiving a signal transmitted by a network node, wherein the signal was modulated using a training sequence (TS). The method also includes producing a feature based on the received signal (e.g., I or Q component of a baseband sample of the signal). The method also includes generating the TS that was used to modulate the signal, wherein the generating comprises using a pseudo-random sequence generator (pRSG) to generate the TS. The method also includes generating a training example comprising the feature and a label, wherein the label comprises the generated TS.

The project leading to this application has received funding from the European Union's Horizon 2020 research and innovation program under grant agreement No 101015956.

### TECHNICAL FIELD

Disclosed are embodiments related to generating training examples for a machine learning (ML) based receiver.

### BACKGROUND

A receiver is an entity that receives transmitted data and detects the transmitted data. The data can be transmitted over a wireless channel, through an optical fiber, or through wired channel. The transmitted data may be subject to some distortions depending on the transmission channel and the hardware at the transmitter and receiver. A receiver usually experiences operating conditions that change over time and/or frequency and/or space (e.g., a wireless transmission channel may vary due to weather conditions, the performance of a power amplifier (PA) in the transmitter may change over time). Because these changes are generally unknown, they need to be estimated by the receiver for the receiver to achieve optimal performance. That is, to cope with these varying operating conditions, the receiver can make adjustments (e.g., change parameter values) depending on the conditions under which the receiver is operating.

### Machine Learning

Machine learning (ML) refers to a technique that uses training data (a.k.a., a training dataset or training examples) for training a model that can be used for various applications including inference, classification, and/or prediction. ML algorithms can be classified into online and offline algorithms, where the offline algorithms rely on pre-trained models while the online algorithms can train a model on the fly while receiving new data samples. Another fundamental distinction is between supervised ML, unsupervised ML, and reinforcement learning. In the supervised learning paradigm, each training example in a training dataset comprise input data (a.k.a., feature) paired with corresponding output data (a.k.a., label). That is, in supervised learning, the model is trained using a labeled dataset, whereas in unsupervised learning, the training dataset is not labeled.

### Artificial Neural Networks

Artificial neural networks are a class of machine learning algorithms that are widely used due to their capability to approximate any general function based on training datasets, and their inherent parallel processing which make these techniques attractive candidates for implementation on emerging artificial intelligence (AI) accelerator hardware. A neural network is based on interconnected processing units called neurons as depicted in FIG. 1, where each neuron receives weighted version of the other neuron's outputs and compute the output based on a nonlinear transformation of the aggregated inputs using an activation function.

### ML Receiver Methods

As illustrated in FIG. 2, in a transmitter/receiver architecture, ML methods can be used at the receiver side to optimize one or multiple functionalities at the receiver. For example, an ML receiver method based on neural networks (NN) is proposed in reference [1] and reference [2] to optimize the demapper (a single functionality) to compensate the hardware impairments due to oscillator phase noise. FIG. 2 shows a receiver chain 200 with an example of a single functionality (the soft demapper) replaced by a ML agent (i.e., the ML-based soft demapper).

One possible implementation of a neural network receiver is illustrated in FIG. 3. The structure in FIG. 3 performs soft symbol-by-symbol demapping, taking the I and Q components of a complex baseband sample, context information, and signal-to-noise ratio (SNR) estimate as inputs and generates soft bits as the output. Such a demapper will help improve the performance of a system that is under the influence of radio frequency (RF) impairments such as power amplifier (PA) nonlinearity. The performance of this ML-based method in comparison with a baseline method is illustrated in FIG. 4.

### Neural Network (NN) Training

Training of NNs refers to adjusting the NN's parameters (e.g., weights and bias values) based on the training examples (i.e. a set of feature-label tuples). The aim of training is to improve the accuracy of the NN's results, e.g., reducing the classification error or lowering the prediction error. The training is done by adapting the NN's parameters to minimize a loss function, where the loss function is defined as a measure of distance between the outputs of the neural network for the training features and the training labels. There are several methods for training of neural networks, e.g., the ones based on gradient descent that update the network parameters by backpropagation of the error from the output of the neural network aiming to minimize the loss function.

### SUMMARY

Certain challenges presently exist. For instance, while receiver methods based on ML have been proposed (see, e.g., references [1,2] discussed in the Background section above), these methods assume that training examples are available at the receiver to perform the model training and this assumption is rarely correct. That is, in general, the receiver does not have access to a good set of training examples.

A transmitter can either directly send the training examples to the receiver (in this case, it would mean that examples are sent separately with additional protection for them to be correctly received), which adds overhead and complexity to the transmission, or attempt to construct the label part of the training dataset using the successfully decoded signals using a legacy receiver, or an already trained ML-based receiver (i.e. received data block that passes the CRC check) (see, e.g., references [5] and [6]). But a problem with the latter method is that it collects only samples for which a decoder was capable of successfully decoding the transmitted encoded block. Consequently, samples that experience low signal quality would be missing because they cannot be guaranteed to be successfully decoded. This presents a problem when training a receiver because the receiver will not be able to continuously train and adapt to training data (only blocks that were successfully received) and it will also not be able to cope with specific conditions representative of such low signal quality reception. Such conditions include, among others, low S(I)NRs and/or large RF impairments (e.g., high level of phase noise or non-linear PA operation). Remarkably, these operating regions with low signal quality reception are those where the performance gains from receiver calibration are the most promising (cf. 24 dB SNR point in FIG. 4).

Accordingly, in one aspect there is provided a method performed by a UE for generating training data. The method includes receiving a signal transmitted by a network node, wherein the signal was modulated using a training sequence (TS). The method also includes producing a feature based on the received signal (e.g., I or Q component of a baseband sample of the signal). The method also includes generating the TS that was used to modulate the signal, wherein the generating comprises using a pseudo-random sequence generator (pRSG) to generate the TS. The method also includes generating a training example comprising the feature and a label, wherein the label comprises the generated TS.

In another aspect there is provided a UE configured to perform a method for generating training data. The method includes receiving a signal transmitted by a network node, wherein the signal was modulated using a training sequence (TS). The method also includes producing a feature based on the received signal (e.g., I or Q component of a baseband sample of the signal). The method also includes generating the TS that was used to modulate the signal, wherein the generating comprises using a pseudo-random sequence generator (pRSG) to generate the TS. The method also includes generating a training example comprising the feature and a label, wherein the label comprises the generated TS.

In another aspect there is provided a method performed by a network node for producing training data. The method includes receiving a signal transmitted by a UE, wherein the signal was modulated using a training sequence (TS) generated by the UE. The method also includes producing a feature based on the received signal (e.g., I or Q component of a baseband sample of the signal). The method also includes obtaining the TS that was used to modulate the signal. The method also includes generating a training example comprising the feature and a label, wherein the label comprises the generated TS.

In another aspect there is provided a network node configured to perform a method for producing training data. The method includes receiving a signal transmitted by a UE, wherein the signal was modulated using a training sequence (TS) generated by the UE. The method also includes producing a feature based on the received signal (e.g., I or Q component of a baseband sample of the signal). The method also includes obtaining the TS that was used to modulate the signal. The method also includes generating a training example comprising the feature and a label, wherein the label comprises the generated TS.

In another aspect there is provided a computer program comprising instructions which when executed by processing circuitry of an apparatus, such as, for example, a UE or network node, causes the apparatus to perform any of the methods disclosed herein. In one embodiment, there is provided a carrier containing the computer program wherein the carrier is one of an electronic signal, an optical signal, a radio signal, and a computer readable storage medium.

An advantage of the embodiments disclosed herein is that they lead to lower overhead in transmission because there is no need to send the labels and have lower complexity because there is no need to encode/decode the labels to be reliably transmitted to the receiver. Additionally, the embodiments enable collecting samples for those regimes where blocks are not successfully received, e.g., at low S(I)NRs or when the level of distortions due to hardware impairments is high. These samples are of high importance for training of the receiver methods to compensate hardware impairments since the gain of these methods are most promising at such operation conditions. Moreover, the embodiments enable collecting training samples in scenarios or working conditions for which the pre-trained receiver models are underperforming and re-training is required.

### BRIEF DESCRIPTION OF THE DRAWINGS

The accompanying drawings, which are incorporated herein and form part of the specification, illustrate various embodiments.

FIG. 1 illustrates a neural network.

FIG. 2 illustrates components of an ML-based receiver according to an embodiment.

FIG. 3 illustrates a neural network receiver.

FIG. 4 is a data plot comparing the performance of a ML-based method with a baseline.

FIG. 5 is a signaling diagram according to an embodiment.

FIG. 6 is a signaling diagram according to an embodiment.

FIG. 7A illustrates a transmit format according to an embodiment.

FIG. 7B illustrates a transmit format according to an embodiment.

FIG. 8 illustrates DCI being used to multiplex the transmission of user plane (UP) data and a training sequence (TS) and shows how the UP data and TS are mapped to physical resources.

FIG. 9 is a signaling diagram according to an embodiment.

FIG. 10 illustrates a system according to an embodiment.

FIG. 11 is a flowchart illustrating a process according to an embodiment.

FIG. 13 is a block diagram of a UE according to an embodiment.

FIG. 14 is a block diagram of a network node according to an embodiment.

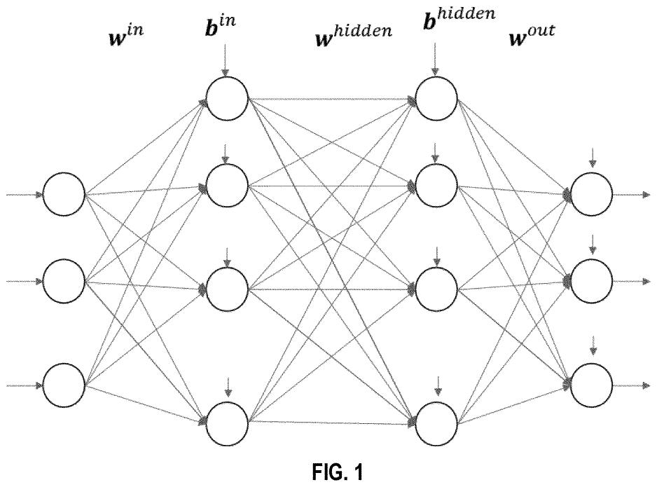

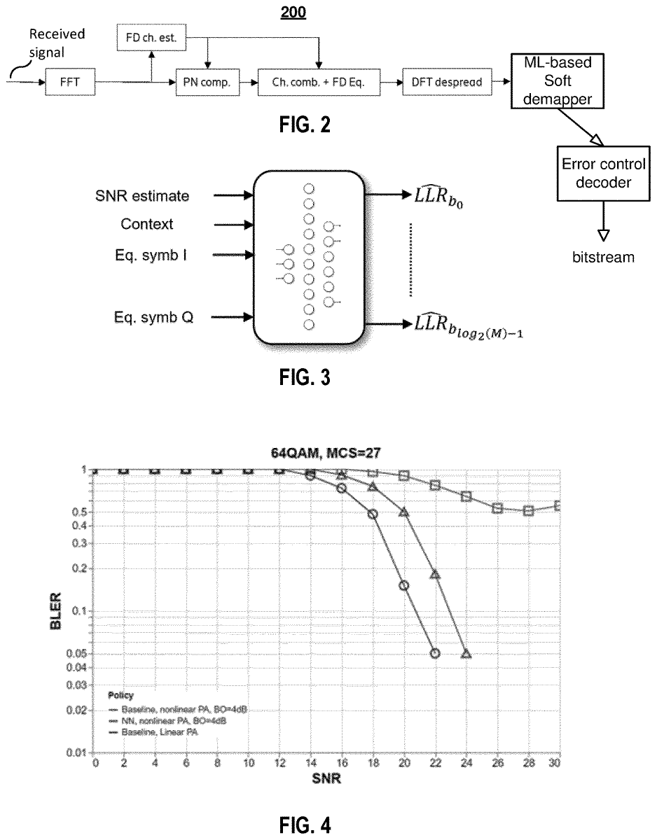

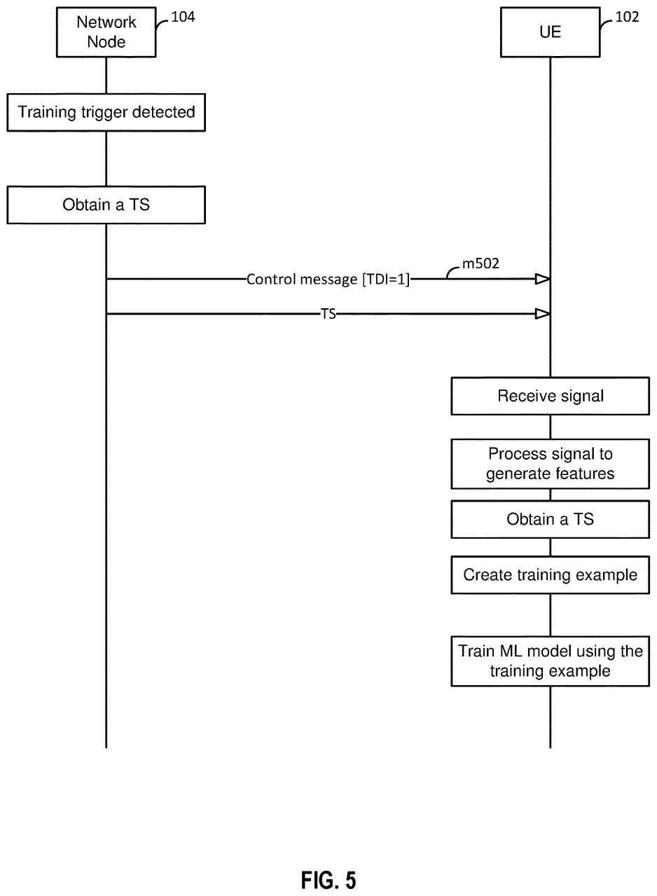

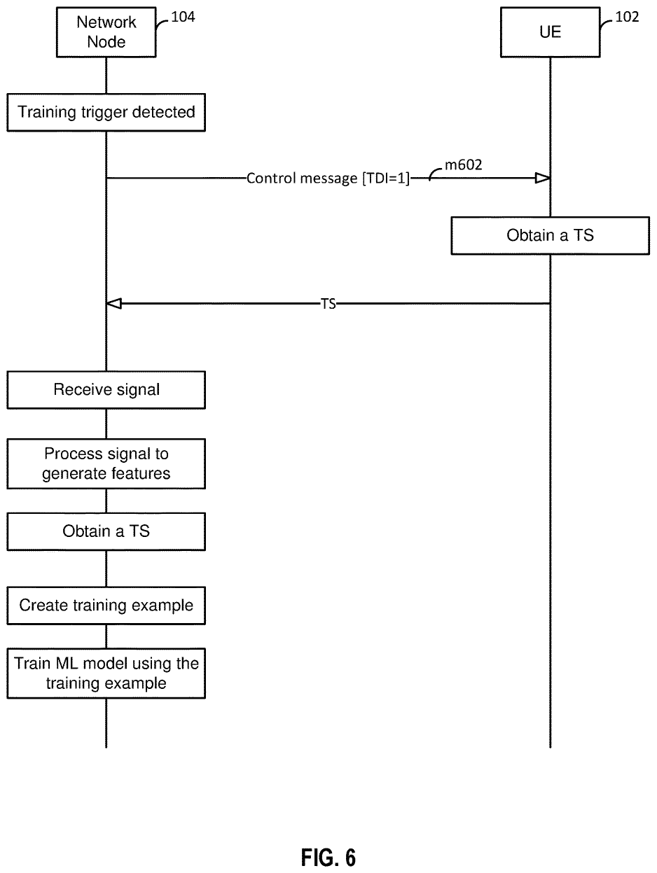

### DETAILED DESCRIPTION

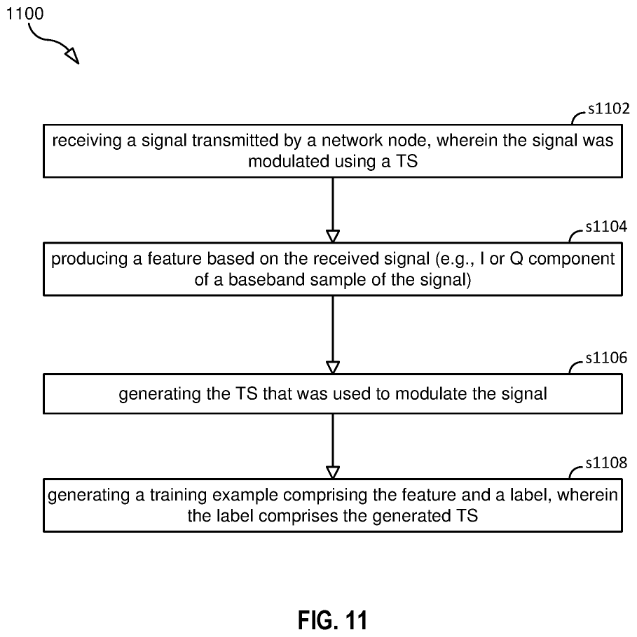

FIG. 10 illustrates a system 100 according to an embodiment. System 100 includes a user equipment (UE) 102 and a network node 104 (in the example shown, network node 104 is a base station or is a component of a base station). As used herein, a UE is any device capable of wireless communication with a network node, such as, for example, a phone, a tablet, a computer, a sensor, an appliance, etc. ; and a network node is any device that provides network access to a UE. UE 102 and/or network node 104 may comprise an ML-based receiver chain (see., e.g., receiver chain 200). This disclosure provides embodiments for acquiring training examples for training the ML model used by the ML-based receiver.

As described above, each training example includes a feature paired with a label. A problem solved by the embodiments is the acquisition of the label part of the training examples. In contrast with prior systems, in the proposed embodiments, the label is generated and/or pre-stored at the ML-based receiver. For example, in one embodiment, the label is a pseudo randomly generated bit string, which is also known as “bitstream” or “training sequence (TS)”, created at the transmitter side by, for example, use of a pRSG and generated at the receiver by use of the same pRSG. By ensuring that both the transmitter (Tx) and the receiver (Rx) obtain the same training sequence (TS), the embodiments reduce overhead because the embodiments do not require the label to be transmitted to the Rx and the embodiments also ensure that new training examples can be acquired irrespective of signal quality. Configuration of the pRSG used in the training process may be communicated to the Rx as part of the training configuration procedure or be hard-coded, such as, for example, specified in a 3rd Generation Partnership Project (3GPP) standard.

pRSGs are described in various 3GPP publications and are used in various parts of 3GPP systems to generate sequences of pseudo-random numbers for various purposes, such as generating spreading codes in spread-spectrum communications, generating keys for encryption, and generating masks for channel coding. 3GPP specifies a number of pRSGs that may be used in different parts of the system, and provides detailed descriptions of their design and operation. For example, 3GPP technical specification (TS) 38.211 V17.4.0, Sections 7.4.1.1.1 and 5.2.1 and describes the use of binary pRSGs for generating the demodulation reference signal for physical downlink shared channel (PDSCH) in 5G NR. pRSGs use a seed, generally in form of a number or vector, to initialize the pseudorandom number generator.

In the context of this disclosure, the ML-based receiver employs the supervised learning paradigm, where during a training phase, the ML parameters are iteratively adjusted using training examples, i.e., feature-label tuples. In one embodiment, the label part of the training example is a length-N (N>0) vector of binary values representing a sequence of bits that has a one-to-one mapping to a complex-valued symbol from a set of 2^{N} symbols (e.g. a 2^{N}-QAM symbol)—this length-N vector of binary values is referred to herein as a training sequence (TS). Typical values of N are 4, which maps to a 16-level modulation, e.g. 16-QAM, and 6, which maps to a 64-level modulation, e.g. 64-QAM. The feature part of the training example comprises the I and Q values of the complex symbol to which the training sequence maps, with the symbol seen by the receiver, i.e. corrupted by transmitter and receiver nonlinearities, wireless channel effects and thermal noise. In another embodiment, the feature comprises, in addition to the I and Q values of the received complex symbol, also the estimate of the SNR and context information, such as, for example, power level of the PA. In another embodiment, the feature is the value of the received complex-valued symbol after channel equalization.

In one embodiment, multiple TSs are created from a single length-L sequence, i.e., vector of binary values. For example, the length-L sequence may be generated using a pRSG and seed value and then divided into LIN length-N subsections, thereby creating L/N TSs, where each TS is mapped to a complex-valued symbol whose received version is used as part of the feature, forming thus LIN training examples. Typically, a large number of training examples are needed for the training of the ML-based receiver, so L is likewise typically large, such as, for example, on the order of thousands or tens of thousands. In one embodiment, the length-L sequence is encoded by an error correcting code prior to the division to subsections and mapping to complex-valued symbols. In one embodiment, labels are subsections of the length-L sequence prior to the application of the error correcting code, i.e. the ML-based receiver implements jointly the symbol-to-bit demapping and channel decoding. In another embodiment, the labels are subsections of the length-L sequence resulting from the encoding of the sequence by the error correcting code, i.e. the ML-based receiver implements the symbol-to-bit demapping only.

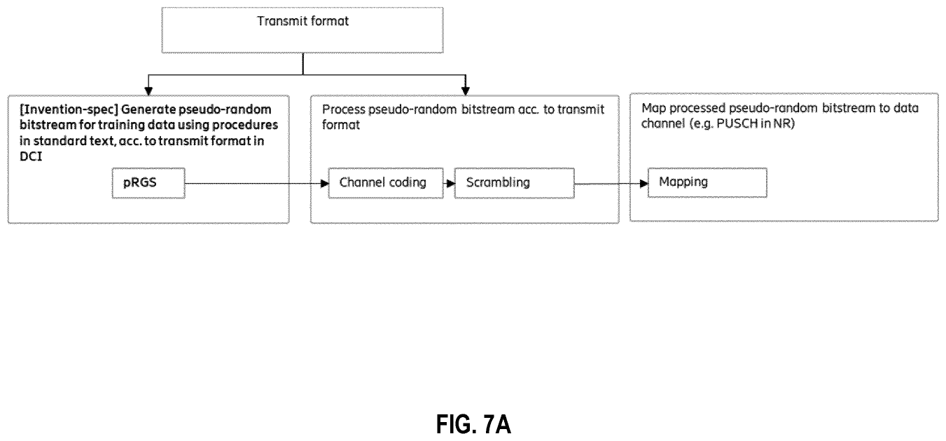

FIG. 5 is a signaling diagram illustrating a process according to one embodiment. In this embodiment, UE 102 comprises the ML-based receiver and generates a set of one or more training examples for use in training the ML model employed by the ML-based receiver.

In the example shown in FIG. 5, network node 104 detects a training trigger (e.g., an event) that triggers the network node to initiate a training process. The trigger could be, for example, the expiration of a timer, the receipt of a control message from an operation and management system, or the receipt of a training data request message from UE 102.

After detecting the training trigger, the network node obtains a training sequence (TS), such as, for example, a pseudo-random bitstream. In one embodiment, the network node obtains the TS by employing a pRSG to generate a pseudo-random sequence (PRS). In one embodiment, the generated PRS is the TS. In one embodiment, the procedure for generating the TS is standardized. In one embodiment, the TS is generated following a single pRSG procedure that produces a PRS. This step may be followed by a scrambling procedure that scrambles the PRS where such scrambling is ensured to vary over time taking for example timing information on, for example, slot, frame or radio frame ID, in the generation of the scrambled sequence. For instance, a scrambling code, i.e., a bit or bits, may be selected based on the slot or frame in which the TS will be transmitted and a scrambled TS can be generated by XORing the pRSG generated PRS with the selected scrambling code, thereby generated the TS that will be transmitted.

Also, after detecting the training trigger, the network node transmits to the UE a control message m502, such as, for example, Downlink Control Information (DCI), a Radio Resource Control (RRC) message, a Media Access Control (MAC) Control Element (CE), that indicates to the UE that a TS for use in generating a training example will be transmitted.

In one embodiment, the control message includes a training data indicator (TDI) to provide the indication to the UE. The TDI may consist of a single bit or multiple bits. In one embodiment, the TDI is explicitly included in the control message. In another embodiment, the TDI is bit-wise XOR'ed with the cyclic redundancy check (CRC) bits of the control message.

The control message may also contain transmission format information indicating the transmission format that the network node will use to transmit the TS. This transmission format information enables the UE to receive the TS. For example, the transmission format information may include: a channel coding identifier indicating a channel coding that will be used to transmit the TS, information identifying the resource elements, such as, for example, physical resources in time/frequency, that will be used to transmit the RS, a modulation and coding scheme (MCS) indicator indicating the MCS used to modulate the TS, information indicating the scrambling sequence that will be used to transmit the TS, and layer mapping information.

The TS obtained by the network node (e.g. the pRSG TS or the scrambled TS) may be associated with state information, such as, for example, a seed value or scrambling code, where such state information ensures randomization of the TS generated over time. Such state information could be explicitly signaled in the control message or implicitly determined by, for example, defining it to be generated using the example timing information described above.

After transmitting the control message m502, the network node transmits the TS. For example, the TS is transmitted according to the MCS indicated in the control message. More specifically, the network node transmits a signal modulated using the TS. Preferably, the modulation is a multi-level modulation, i.e., not binary modulation. For example, 64 QAM modulation is used.

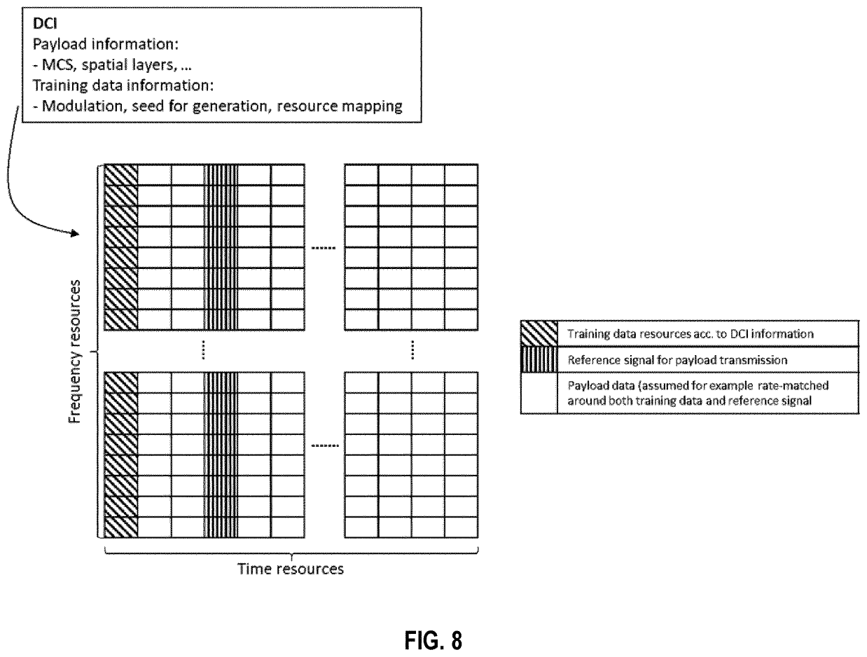

In one embodiment, as shown in FIG. 7A, the process of transmitting the TS includes channel-encoding and scrambling the TS; whereas in another embodiment, as shown in FIG. 7B, the channel-encoding and scrambling are omitted. In either case, the TS is mapped to a data channel, such as, for example, the Physical Downlink Shared Channel (PDSCH) or Physical Uplink Shared Channel (PUSCH). That is, one more specific resources, such as, for example, Orthogonal Frequency Division Multiplexing (OFDM) symbols, are used to transmit the TS.

In order for the transmitting and receiving nodes to be coordinated on the mapping of the TS to radio resources, the MAC/PHY procedures for a regular downlink (DL) data transmission may be followed (see, e.g., FIG. 7A). This is here referred to as the transmit format and could for example include channel coding, resource allocation to physical resources in time/frequency, modulation and coding scheme (MCS), scrambling sequence, layer mapping. As noted above, in one embodiment, the TS used for training the ML model can be channel-encoded and potentially scrambled. Hence, the TS could in this case be seen as the payload of a data transmission.

As shown in FIG. 5, the UE receives the modulated signal carrying the TS and processes the signal (e.g., demodulation, equalization, signal-to-noise (SNR) measurement, etc.) using conventional receiver technology to create features, such as, for example, the I and Q components of a complex baseband sample of the signal, context information, such as, for example, power amplifier (PA) backoff, speed of movement, etc., and signal-to-noise ratio (SNR) estimate.

The UE also obtains a label, i.e., the same TS that the network node transmitted. For example, the UE uses the same state information as used by the network node to obtain (e.g., generate) the TS. Alternatively, the UE may retrieve the TS from a pool of TSs stored at the UE. For example, each TS included in the pool may be associated with an index value and the control message includes the index value of the TS that is transmitted to the UE. In this way, the UE will obtain the same TS that the network node obtained and transmitted to the UE. The UE then generates a training example where the features of the training example comprise the information described above, such as, for example, I/Q symbols, SNR values, context information, and the label of the training example comprises the obtained TS. This training example can then be used to train an ML model used by the UE. The UE itself may perform the training or the UE may provide the training example to a server that then performs the training using the training example.

The process of generating the TSs at the transmitter and at the receiver is similar to the process of generating reference signals, such as, for example, DMRS, CSI-RS, PTRS. However, standardized reference signals are often optimized to give certain waveform characteristics, such as, for example, limited envelope variation, that are different from that of the data-carrying waveform and are inadequate for training of a machine-learning-based receiver. Training data for an ML-based receiver needs to resemble, statistically and in the shape of the waveform, the user-plane data. This data and its corresponding waveform will activate some operation points, such as, for example, cause excessive nonlinear distortion, that a standard reference signal might not activate.

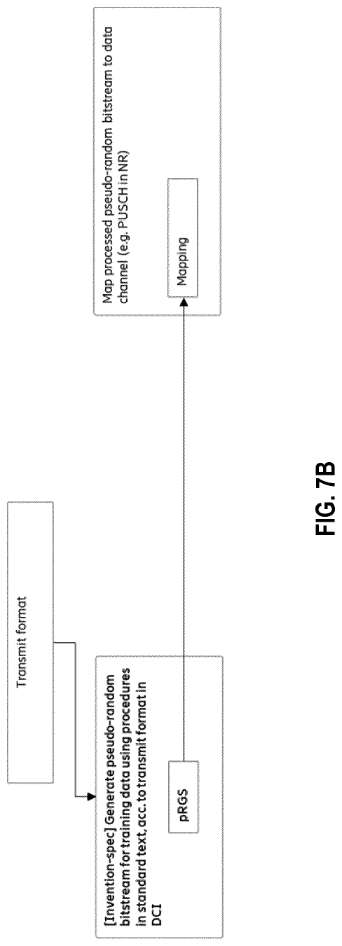

FIG. 6 is a signaling diagram illustrating a process according to another embodiment. In this embodiment, network node 104 comprises the ML-based receiver and generates a set of one or more training examples for use in training the ML model employed by the ML-based receiver.

In the example shown in FIG. 6, network node 104 detects a training trigger that triggers the network node to initiate a training process. The trigger could be, for example, the expiration of a timer or the receipt of a control message from an operation and management system.

After detecting the training trigger, the network node transmits to UE 102 a control message m602, such as, for example, DCI, an RRC message, a MAC CE, that instructs the UE to transmit a specific TS so that the network node can produce a training example. In one embodiment, the control message includes a TDI that provides the indication to the UE. The TDI may consist of a single bit or multiple bits. In one embodiment, the TDI is explicitly included in the control message. In another embodiment, the TDI is bit-wise XOR'ed with the cyclic redundancy check (CRC) bits of the control message (having implications on the false detection rate of the control message decoding, but leaving the control message definitions intact).

The control message may also contain transmission format information (described above) indicating the transmission parameters that the UE must use to transmit the TS. The control message may further contain information for enabling the UE to generate the specific TS. For example, the information may include a seed value and/or scrambling code. In another embodiment, the control message may further contain information for enabling the UE to retrieve the specific TS from a pool of TSs stored at the UE. For example, the information may include a TS index value.

In response to receiving the control message and determining that the control message instructs the UE to transmit a specific TS, the UE performs a process that includes obtaining the TS. In one embodiment, the UE obtains the TS by employing a pRSG to generate the TS. In one embodiment, the procedure for generating the TS is standardized. In one embodiment, the TS is generated following a single pRSG procedure. This step may be followed by the above described scrambling procedure.

The TS obtained by the UE may be associated with state information, where such state information ensures randomization of the TS generated over time. Such state information could be explicitly signaled in the control message or implicitly determined by, for example, defining it to be generated using the example timing information described above.

After obtaining the TS, the UE transmits the TS using radio resources, such as, for example, radio resources identified in the control message. In some embodiments, the UE encodes the TS prior to transmission. More specifically, the network node transmits a signal modulated using the TS. Preferably, the modulation is a multi-level modulation, i.e., not binary modulation. For example, 64 QAM modulation is used.

As shown in FIG. 6, the network node receives the modulated signal carrying the TS and processes the signal (e.g., demodulation, equalization, signal-to-noise (SNR) measurement, etc.) using conventional receiver technology to create features (e.g., in-phase (I) and quadrature (Q) symbol values, measured SNR values, context information regarding the receiver (e.g., power amplifier (PA) backoff).

The network node also obtains a label—i.e., the same TS that the UE transmitted. For example, the network node uses the same procedure as the one used by the UE to obtain (e.g., generate) the TS. In this way, the network node will obtain the same TS that the UE obtained and transmitted to the network node. The network node then generates a training example where the feature of the training example comprises one or more of the features noted above and the label of the training example comprises the obtained TS. This training example can then be used to train an ML model used by the network node.

FIG. 7A illustrates an embodiment in which the Tx (UE or network node) processes the TS prior to transmission. Specifically, in the embodiment shown, the TS is channel encoded and then scrambled. The encoded and scrambled TS is then mapped to a data channel, such as, for example, the resource elements (REs) in which the TS will be transmitted are selected. FIG. 7B illustrates an embodiment in which the Tx does not encode and/or scramble the TS prior to the mapping.

In the above embodiments, the transmit format for the TS follows the same procedure as for existing user plane (UP) data transmission and that the TS essentially replaces a regular UP transmission, but this is not required. For example, it could be beneficial to multiplex (transmit using interleaved radio resources in frequency and/or time) UP data with a TS. In such case, there could be different transmit formats used for the UP data and the TS, and, part of, or the full, transmit formats could be dynamically communicated in the control message, semi-statically configured by RRC, or configured by specification text. A combination of one or more configurations can also be used to arrive at the information needed. For example, the resource mapping could be defined by RRC, procedure around determining the seed for generating the TS could be defined by a specification, while data aspects related to the training data collection (e.g. modulation used, number of spatial layers) could be indicated dynamically by the control message.

To be more concrete, the generated TS can be mapped to a specific set of resources, e.g. one or more OFDM symbols in an NR transmission. That is, for example, the TS is transmitted using the specific set of OFDM symbol(s) (e.g., the first OFDM symbol in a subframe). Such resources could be rate-matched or punctured, i.e., the training data is overriding/replacing the mapped payload resource value, around a payload transmission in the same set of resources. In some embodiments, one modulation and coding scheme (MCS) is used to transmit he UP data, while a different MCS is used to transmit the TS.

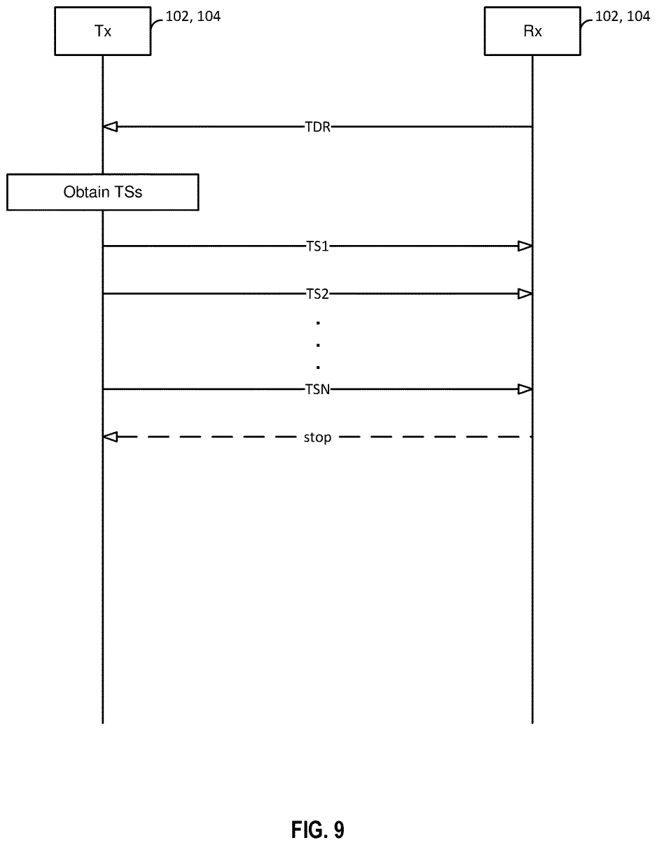

An illustrative mapping is shown in FIG. 8, which shows DCI scheduling the DL or UL transmission (indicated by the arrow) includes not only information about the UP data to be transmitted and associated reference signal(s) (RSS), but also information about the TS. In this case, the information about the TS includes a modulation indicator (that can be different from the UP data), a seed for the TS generation, and a resource mapping. The resource mapping in this example is simply placing the TS in the first time resource symbol. Other more elaborate mapping options, such as an interleaved allocation over a time/frequency resource grid are also envisioned.

In an embodiment, the TS could be used as a demodulation reference signal (DMRS) for the UP data, in which case the UP DMRS can be omitted.

In addition to the aperiodic/dynamic transmission of training data, the training data may also be configured for periodic or semi-persistent transmission following principles and signaling similar to those used for the scheduling of reference signals.

In order to reduce overhead and/or UE complexity, such as, for example, by limiting the training to the subset of UEs that require it, the TDI, state information, and/or TSs for training may be transmitted in a broadcast or multi-cast manner, such as, for example, via the Multicast and Broadband Services (MBS) Control Channel (MCCH) and/or the MBS Traffic Channel (MTCH) and/or group-based DCI. For example, a network node may broadcast a set of one or more TSs that may be utilized by several UEs for training.

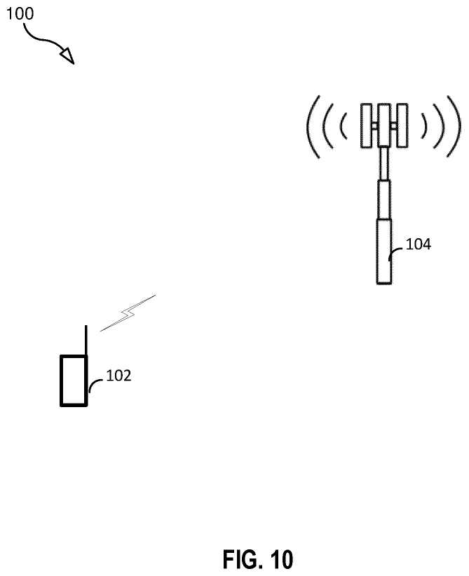

In some embodiments, the Rx (network node 104 or UE 102) may indicate when and which training data it needs for training its model (as used herein training a model refers not just to the initial training but also re-training). For example, the Rx may monitor its performance and if Rx detects that the performance has fallen below a threshold, then this event triggers the Rx to request a Tx to transmit a TS so that the Rx can generate new training examples. An example of this embodiment is illustrated in FIG. 9, which shows the Rx transmitting to the Tx a training data request (TDR).

In one embodiment, the TDR is a single bit. When the Rx is the UE, the TDR may be included in an UL control message (e.g. by a Physical Uplink Control Channel (PUCCH) transmission) similar to existing functionality in the NR specification (using PUCCH for uplink control information (UCI) transmission); when the Rx is the network node, the TDR may be included in a DL control message (e.g., DCI, MAC CE, RRC message) similar to existing functionality in the NR specification (e.g., using Physical Downlink Control Channel (PDCCH) transmission to trigger a UE to transmit a sounding reference signal (SRS)).

In another embodiment, the TDR consist of two or more bits. The TDR could be carried in UCI or DCI, transmitted on specific control channels (e.g. for uplink PUCCH in NR) or multiplexed with data (e.g. PUSCH in NR). Alternatively, the TDR can be included in a MAC control element (MAC CE). In this embodiment where the TDR is more than a single bit, the TDR can indicate not only a request for the Tx to transmit a TS (i.e., a request for training data) but also: what type of TS is requested, the number (N) of TSs to transmit, and the transmit format to be used for the transmission of the TSs. The indicated transmit format could for example include: the modulation to be used (e.g. if the receiver estimates that it is not well functioning on 64 QAM modulation, it requests for additional training data using this modulation order); the number of spatial layers/streams the receiver wants to receive training data on (similarly to the modulation, it estimates that the model need to be improved in this operating regime); and the hardware configuration the receiver wants to receive training data on.

Similarly to requesting activation of training data, the Rx can use similar channels and procedures for stopping the transmission of training data. For example, as shown in FIG. 9, the Rx may send a stop training message to the Tx to cause the Tx to stop sending TSs.

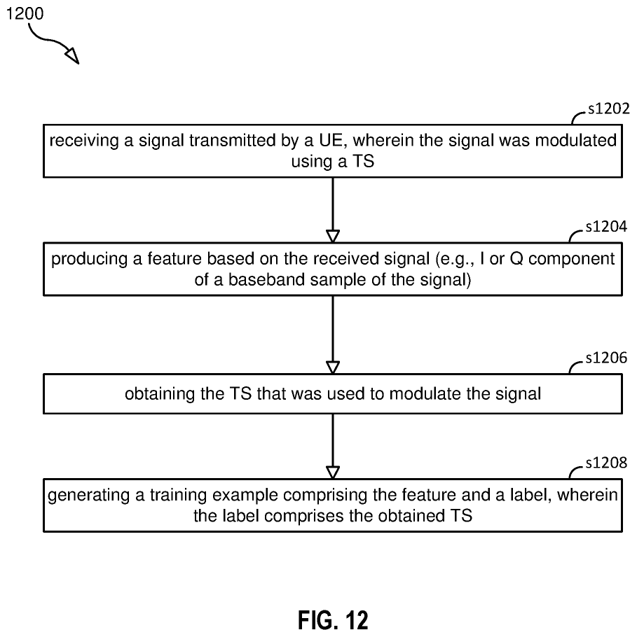

FIG. 11 is a flow chart illustrating a process 1100, according to an embodiment, performed by UE 102 for producing training data. Process 1100 may begin in step s1102. Step s1102 comprises receiving a signal transmitted by a network node (104), wherein the signal was modulated using a training sequence, TS. Step s1104 comprises producing a feature based on the received signal (e.g., I or Q component of a baseband sample of the signal). Step s1106 comprises generating the TS that was used to modulate the signal, wherein the generating comprises using a pseudo-random sequence generator, pRSG, to generate the TS. Step s1108 comprises generating a training example comprising the feature and a label, wherein the label comprises the generated TS.

FIG. 12 is a flow chart illustrating a process 1200, according to an embodiment, performed by network node 104 for producing training data. Process 1200 may begin in step s1202. Step s1202 comprises receiving a signal transmitted by a user equipment, UE, (102), wherein the signal was modulated using a training sequence, TS, generated by the UE. Step s1202 comprises producing a feature based on the received signal (e.g., I or Q component of a baseband sample of the signal). Step s1206 comprises obtaining the TS that was used to modulate the signal. Step s1208 comprises generating a training example comprising the feature and a label, wherein the label comprises the generated TS.

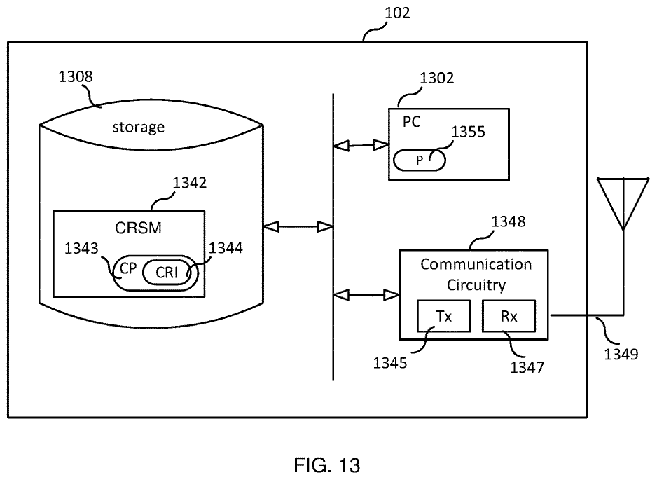

FIG. 13 is a block diagram of UE 102, according to some embodiments. As shown in FIG. 13, UE 102 may comprise: processing circuitry (PC) 1302, which may include one or more processors (P) 1355 (e.g., one or more general purpose microprocessors and/or one or more other processors, such as an application specific integrated circuit (ASIC), field-programmable gate arrays (FPGAs), and the like); communication circuitry 1348, which is coupled to an antenna arrangement 1349 comprising one or more antennas and which comprises a transmitter (Tx) 1345 and a receiver (Rx) 1347 for enabling UE 102 to transmit data and receive data (e.g., wirelessly transmit/receive data); and a storage unit (a.k.a., “data storage system”) 1308, which may include one or more non-volatile storage devices and/or one or more volatile storage devices. In embodiments where PC 1302 includes a programmable processor, a computer readable storage medium (CRSM) 1342 may be provided. CRSM 1342 may store a computer program (CP) 1343 comprising computer readable instructions (CRI) 1344. CRSM 1342 may be a non-transitory computer readable medium, such as, magnetic media (e.g., a hard disk), optical media, memory devices (e.g., random access memory, flash memory), and the like. In some embodiments, the CRI 1344 of computer program 1343 is configured such that when executed by PC 1302, the CRI causes UE 102 to perform steps described herein (e.g., steps described herein with reference to the flow charts). In other embodiments, UE 102 may be configured to perform steps described herein without the need for code. That is, for example, PC 1302 may consist merely of one or more ASICs. Hence, the features of the embodiments described herein may be implemented in hardware and/or software.

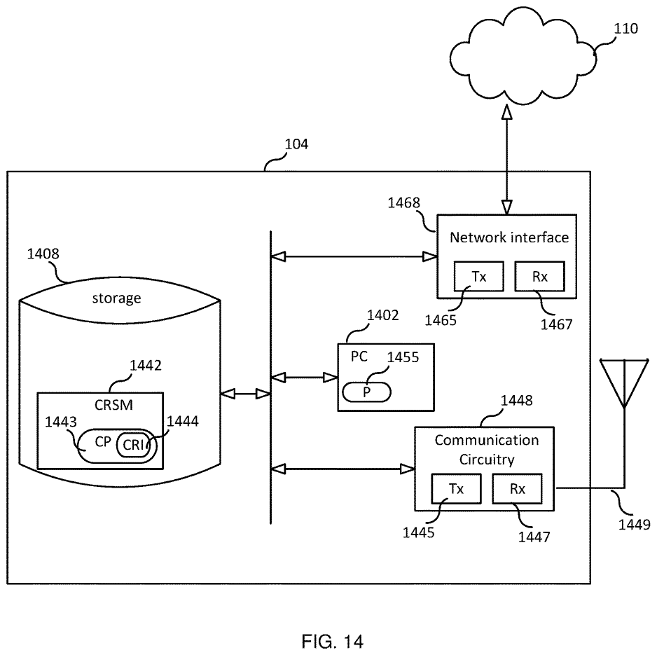

FIG. 14 is a block diagram of network node 104, according to some embodiments for performing the network node methods disclosed herein. As shown in FIG. 14, network node 104 may comprise: processing circuitry (PC) 1402, which may include one or more processors (P) 1455 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., network node may be a distributed computing apparatus); a network interface 1468 comprising a transmitter (Tx) 1465 and a receiver (Rx) 1467 for enabling network node 104 to transmit data to and receive data from other nodes connected to a network 110 (e.g., an Internet Protocol (IP) network) to which network interface 1468 is connected; communication circuitry 1448 (e.g., radio transceiver circuitry comprising an Rx 1447 and a Tx 1445) coupled to an antenna system 1449 for wireless communication with UEs or other nodes; and a storage unit (a.k.a., “data storage system”) 1408, which may include one or more non-volatile storage devices and/or one or more volatile storage devices. In embodiments where PC 1402 includes a programmable processor, a computer readable storage medium (CRSM) 1442 may be provided. CRSM 1442 may store a computer program (CP) 1443 comprising computer readable instructions (CRI) 1444. CRSM 1442 may be a non-transitory computer readable medium, such as, magnetic media (e.g., a hard disk), optical media, memory devices (e.g., random access memory, flash memory), and the like. In some embodiments, the CRI 1444 of computer program 1443 is configured such that when executed by PC 1402, the CRI causes network node 104 to perform steps described herein (e.g., steps described herein with reference to one or more flow charts). In other embodiments, network node 104 may be configured to perform steps described herein without the need for code. That is, for example, PC 1402 may consist merely of one or more ASICs. Hence, the features of the embodiments described herein may be implemented in hardware and/or software.

### Summary of Various Embodiments

A1. A method performed by a user equipment, UE, for generating training data, the method comprising: receiving a signal transmitted by a network node, wherein the signal was modulated using a training sequence, TS; producing a feature based on the received signal (e.g., I or Q component of a baseband sample of the signal); generating the TS that was used to modulate the signal, wherein the generating comprises using a pseudo-random sequence generator, pRSG, to generate the TS; and generating a training example comprising the feature and a label, wherein the label comprises the generated TS.
A2. The method of embodiment A1, further comprising using the training example to train a machine learning, ML, model.
A3. The method of embodiment A1 or A2, further comprising: prior to receiving the signal, receiving from the network node a control message (m502) indicating that the network node will transmit the signal.
A4. The method of embodiment A3, wherein the control message comprises a seed value; and generating the TS comprises using the seed value as an input to the pRSG.
A5. The method of embodiment A3, wherein the method further comprises determining a seed value based on information indicated by the control message (i.e., information indicating the slot/frame in which the signal will be transmitted), and generating the TS comprises using the seed value as an input to the pRSG.
A6. The method of any one of embodiments A3-A5, wherein the control message is downlink control information, DCI, the control message is a MAC control element, MAC CE, the control message is a radio resource control, RRC, message, the control message is a broadcast message, or the control message is a multi-cast message.
A7. The method of any one of embodiments A1-A6, wherein generating the TS comprises using a seed value as an input to the pRSG to produce a pseudo-random sequence, PRS, and scrambling the PRS with a scrambling code to produce the TS.
A8. The method of any one of embodiments A1-A7, further comprising: prior to receiving the signal, transmitting to a network node a training data request message requesting the network node to transmit one or more TSs.
A9. The method of embodiment A8, wherein the data request message indicates the number of TSs that are being requested to be sent.
A10. The method of embodiment A2, wherein the ML model functions as a symbol-to-bit demapper (i.e., is configured to produce soft bits).
A11. The method of any one of embodiments A1-A10, wherein using the pRSG to generate the TS comprises: using the pRSG to generate a vector of binary values, wherein the vector has a length of L, and L>1; and using the vector of binary values to generate the TS.
A12. The method of embodiment A11, wherein the TS is a subsection of the vector of binary values.
A13. The method of embodiment A11, wherein using the vector of binary values to generate the TS comprises using an error correcting code to produce an encoded version of the vector of binary values, wherein the TS is a subsection of the encoded version of the vector of binary values.
B1. A method performed by a network node for producing training data, the method comprising: receiving a signal transmitted by a user equipment, UE,, wherein the signal was modulated using a training sequence, TS, generated by the UE; producing a feature based on the received signal (e.g., I or Q component of a baseband sample of the signal); obtaining the TS that was used to modulate the signal; and generating a training example comprising the feature and a label, wherein the label comprises the generated TS.
B2. The method of embodiment B1, further comprising using the training example to train a machine learning, ML, model.
B3. The method of embodiment B1 or B2, further comprising transmitting to the UE a control message (m602) instructing the UE to transmit the signal.
B4. The method of embodiment B3, wherein the control message comprises a seed value for enabling the UE to generate the TS.
B5. The method of embodiment B4, wherein obtaining the TS comprises generating the TS using the seed value as an input to a pseudo-random sequence generator, pRSG.
B6. The method of any one of embodiments B3-B5, wherein the control message is downlink control information, DCI, the control message is a MAC control element, MAC CE, or the control message is a radio resource control, RRC, message.
B7. The method of any one of embodiments B1-B6, wherein obtaining the TS comprises using a seed value as an input to a pRSG to produce a pseudo-random sequence, PRS, and scrambling the PRS with a scrambling code to produce the TS.
B8. The method of any one of embodiments B1-B5, further comprising: prior to receiving the signal, transmitting to the UE a training data request message requesting the UE to transmit one or more TSs.
B9. The method of embodiment B8, wherein the training data request message indicates the number of TSs that are being requested to be sent.
B10. The method of embodiment B2, wherein the ML model functions as a symbol-to-bit demapper (i.e., is configured to produce soft bits).
C1. A computer program comprising instructions which when executed by processing circuitry of a UE causes the UE to perform the method of any one of claims A1-A10.
C2. A computer program comprising instructions which when executed by processing circuitry of a network node causes the network node to perform the method of any one of claims B1-B10.
C3. A carrier containing the computer program of embodiment C1 or C2, wherein the carrier is one of an electronic signal, an optical signal, a radio signal, and a computer readable storage medium (1342, 1442).
D1. A user equipment, UE,, configured to generate training data, the UE being operative to: receive a signal transmitted by a network node, wherein the signal was modulated using a training sequence, TS; produce a feature based on the received signal (e.g., I or Q component of a baseband sample of the signal); generate the TS that was used to modulate the signal, wherein the generating comprises using a pseudo-random sequence generator, pRSG, to generate the TS; and generate a training example comprising the feature and a label, wherein the label comprises the generated TS.
D2. A user equipment, UE, configured to generate training data, the UE comprising processing circuitry and a storage unit, the storage unit comprising computer readable instructions executable by the processing circuitry, whereby the UE is operative to: receive a signal transmitted by a network node, wherein the signal was modulated using a training sequence, TS; produce a feature based on the received signal (e.g., I or Q component of a baseband sample of the signal); generate the TS that was used to modulate the signal, wherein the generating comprises using a pseudo-random sequence generator, pRSG, to generate the TS; and generate a training example comprising the feature and a label, wherein the label comprises the generated TS.
D3. The UE, of embodiment D1 or D2, wherein the UE is further operative to perform the method of any one of embodiments A2-A13.
E1. A network node, the network node being operative to: receive a signal transmitted by a user equipment, UE,, wherein the signal was modulated using a training sequence, TS, generated by the UE; produce a feature based on the received signal (e.g., I or Q component of a baseband sample of the signal); obtain the TS that was used to modulate the signal; and generate a training example comprising the feature and a label, wherein the label comprises the generated TS.
E2. A network node configured to generate training data, the network node comprising: a processing circuitry and a storage unit, the storage unit comprising computer readable instructions executable by the processing circuitry, whereby the network node is operative to:
E3. The network node of embodiment E1 or E2, wherein the network node is further operative to perform the method of any one of embodiments B2-B10.

### Conclusion

The embodiments disclosed above are advantageous in that they enable an Rx to generate training examples in a way that does not consume valuable network resources.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### References

[1] International Patent Application Publication No. WO2021262052, titled, “A CONTEXT AWARE DATA RECEIVER FOR COMMUNICATION SIGNALS BASED ON MACHINE LEARNING.”
[2] H. Farhadi and M. Sundberg, “Machine learning empowered context-aware receiver for high-band transmission,” IEEE Globecom Workshops, 2020.
[3] International Patent Application No. PCT/SE2022/050730, titled “A method of adaptive neural network receive.”
[4] International Patent Application No. PCT/SE2022/050667, titled, “A method of adaptive transmit signal quality for capable receivers.”
[5] Fischer, Moritz Benedikt, et al. “Adaptive Neural Network-based OFDM Receivers.” 2022 IEEE 23rd International Workshop on Signal Processing Advances in Wireless Communication (SPAWC), IEEE, 2022.
[6] Schibisch, Stefan, et al. “Online label recovery for deep learning-based communication through error correcting codes.” 2018 15th International Symposium on Wireless Communication Systems (ISWCS), IEEE, 2018.

1. A method performed by a user equipment (UE) for generating training data, the method comprising:
receiving a signal transmitted by a network node, wherein the signal was modulated using a training sequence (TS);
producing a feature based on the received signal;
generating the TS that was used to modulate the signal, wherein the generating comprises using a pseudo-random sequence generator (pRSG) to generate the TS; and
generating a training example comprising the feature and a label, wherein the label comprises the generated TS.

2. The method of claim 1, wherein the method further comprises using the training example to train a machine learning (ML) model.

3. The method of claim 1, wherein the method further comprises:
prior to receiving the signal, receiving from the network node a control message indicating that the network node will transmit the signal.

4. The method of claim 3, wherein
the control message comprises a seed value; and
generating the training sequence comprises using the seed value as an input to the pRSG.

5. The method of claim 3, wherein
the method further comprises determining a seed value based on information indicated by the control message, and
generating the training sequence comprises using the seed value as an input to the pRSG.

6. The method of claim 3, wherein
the control message is downlink control information,
the control message is a MAC control element,
the control message is a radio resource control message,
the control message is a broadcast message, or
the control message is a multi-cast message.

7. The method of claim 1, wherein
generating the TS comprises using a seed value as an input to the pRSG to produce a pseudo-random sequence, PRS, and
scrambling the PRS with a scrambling code to produce the TS.

8. The method of claim 1, wherein the method further comprises:
prior to receiving the signal, transmitting to a network node a training data request message requesting the network node to transmit one or more TSs.

9. The method of claim 8, wherein the data request message indicates the number of training sequences that are being requested to be sent.

10. The method of claim 2, wherein the machine learning model functions as a symbol-to-bit demapper.

11. The method of claim 1, wherein using the pRSG to generate the TS comprises:
using the pRSG to generate a vector of binary values, wherein the vector has a length of L, and L>1; and
using the vector of binary values to generate the TS.

12. The method of claim 11, wherein the training sequence is a subsection of the vector of binary values.

13. The method of claim 11, wherein
using the vector of binary values to generate the TS comprises using an error correcting code to produce an encoded version of the vector of binary values, and
the TS is a subsection of the encoded version of the vector of binary values.

14. A method performed by a network node for producing training data, the method comprising:
receiving a signal transmitted by a user equipment (UE), wherein the signal was modulated using a training sequence (TS) generated by the UE;
producing a feature based on the received signal;
obtaining the TS that was used to modulate the signal; and
generating a training example comprising the feature and a label, wherein the label comprises the generated TS.

15. The method of claim 14, wherein the method further comprises using the training example to train a machine learning (ML) model.

16. The method of claim wherein the method further comprises transmitting to the UE a control message instructing the UE to transmit the signal.

17. The method of claim 16, wherein the control message comprises a seed value for enabling the UE to generate the training sequence.

18. The method of claim 17, wherein obtaining the training sequence comprises generating the training sequence using the seed value as an input to a pseudo-random sequence generator.

19-26. (canceled)

27. A user equipment (UE) configured to generate training data, the UE being operative to:
receive a signal transmitted by a network node, wherein the signal was modulated using a training sequence (TS);
produce a feature based on the received signal;
generate the TS that was used to modulate the signal, wherein the generating comprises using a pseudo-random sequence generator (pRSG) to generate the TS; and
generate a training example comprising the feature and a label, wherein the label comprises the generated TS.

28. (canceled)

29. A network node, the network node, being operative to:
receive a signal transmitted by a user equipment (UE), wherein the signal was modulated using a training sequence (TS) generated by the UE;
produce a feature based on the received signal;
obtain the TS that was used to modulate the signal; and
generate a training example comprising the feature and a label, wherein the label comprises the generated TS.

30. (canceled)
